(19) United States
(12) Patent Application Publication
(10) Pub. No.: US 2017/0257533 A1
(43) Pub. Date: Sep. 7, 2017

(54) CAMERA MODULE

(71) Applicant: DENSO CORPORATION, Kariya-city (JP)

(72) Inventors: Daisuke Takama, Kariya-city (JP); Yasuki Furutake, Kariya-city (JP); Soji Masui, Kariya-city (JP)

(21) Appl. No.: 15/446,838

(22) Filed: Mar. 1, 2017

(30) Foreign Application Priority Data
Mar. 3, 2016 (JP) 2016-041186

(51) Int. Cl. H04N 5/225; G02B 7/00; G02B 27/00; G02B 7/02

(52) U.S. Cl. CPC H04N 5/2252; H04N 5/2253; H04N 5/2254; H04N 5/2257; G02B 7/021; G02B 7/006; G02B 27/0006

(57) ABSTRACT

In a camera module, a camera substrate includes an image sensor. A base portion is a case fixed to the camera substrate and includes a through hole passing through an opposing surface that opposes the camera substrate. A tube-shaped lens barrel portion holds a lens therein and is disposed to be continuous with the through hole. An optical filter is fixed to a fixing region formed on an inner wall surface of the opposing surface. The lens barrel portion includes an air hole that communicates from a tip of the lens barrel portion to the through hole, through a tube-shaped wall of the lens barrel portion in a direction of an optical axis of the lens. The opposing surface includes an air channel that communicates between the through hole and a base inner space surrounded by the base portion and the camera substrate. The air channel has a bent shape.

### CROSS-REFERENCE TO RELATED APPLICATION

This application is based on and claims the benefit of priority from Japanese Patent Application No. 2016-041186, filed Mar. 3, 2016. The entire disclosure of the above application is incorporated herein by reference.

### BACKGROUND

Technical Field

The present disclosure relates to a camera module.

Related Art

An on-board camera described in JP-A-2007-225991 includes a lens barrel and a case. The lens barrel has a lens and an approximately tube-shaped lens barrel that holds the lens. The case has a lens barrel holding portion and a case main body portion. The lens barrel holding portion is approximately tube-shaped and holds the lens barrel. The case main body portion is approximately case-like and houses an image sensor therein. An end portion of the lens barrel is fitted into the lens barrel holding portion and fixed by a set screw.

In cases in which an optical filter for improving the quality of a captured image is applied to the above-described on-board camera, in general, the optical filter is fixed with an adhesive to an inner wall on the lens barrel side of the case main body portion in which the image sensor is housed. That is, the optical filter is fixed to the inner wall of the case main body portion opposing the image sensor.

Here, the quality of the captured image deteriorates when foreign matter adheres to the image sensor. Therefore, the space in which the image sensor is present is preferably sealed such that foreign matter does not adhere to the image sensor. However, when the space in which the image sensor is present is sealed, internal pressure may rise during heat-hardening treatment of the adhesive. The adhesive may fail and the optical filter may become displaced.

### SUMMARY

It is thus desired to provide a camera module that suppresses foreign matter from adhering to an image sensor, even in a structure in which a space in which the image sensor is present is not completely sealed.

An exemplary embodiment provides a camera module that includes a camera substrate, a base portion, a lens barrel portion, and an optical filter. The camera substrate includes an image sensor. The base portion is a case that is fixed to the camera substrate so as to surround the image sensor. The base portion includes a through hole that passes through an opposing surface that opposes the camera substrate. The lens barrel portion is tube-shaped and holds a lens therein. The lens barrel portion is disposed so as to communicate with the through hole on an outer wall surface side of the opposing surface. The optical filter is fixed to a fixing region that is a region formed on an inner wall surface of the opposing surface. The fixing region is connected to an inner wall surface of the through hole and surrounds the through hole. The lens barrel portion includes an air hole that communicates from a tip of the lens barrel portion to the through hole, through a tube-shaped wall of the lens barrel portion in a direction of an optical axis of the lens. The opposing surface includes an air channel that communicates between the through hole and a base inner space. The base inner space is a space surrounded by the base portion and the camera substrate, and the through hole. The air channel has a bent shape on a cross-section parallel to the optical axis of the lens.

In the exemplary embodiment, air enters and exits between the base inner and the outside, through the air hole, the through hole, and the air channel. The air hole communicates through the tube-shaped wall of the lens barrel portion, from the tip to the through hole in the optical axis direction. The air channel communicates through the opposing surface of the base portion, from the through hole to the base inner space in which the image sensor is present. In addition, the lens groove has a bent shape on the cross-section parallel to the optical axis of the lens. Therefore, even when foreign matter flows into the air channel from the through hole, the foreign matter tends to remain in the air channel and does not easily flow out into the space in which the image sensor is present. Therefore, foreign matter can be suppressed from adhering to the image sensor, even in a structure in which the space in which the image sensor is present is not completely sealed.

Reference numbers within the parentheses in the claims indicate corresponding relationships with specific means according to an embodiment described hereafter as one aspect, and do not limit the technical scope of the present disclosure.

### BRIEF DESCRIPTION OF THE DRAWINGS

In the accompanying drawings:

FIG. 1 is a perspective view of an outer appearance of a camera apparatus housing a camera module;

FIG. 2 is a perspective view of an outer appearance of the camera module;

FIG. 3 is a cross-sectional view taken along line in FIG. 1;

FIG. 4 is a cross-sectional view taken along line IV-IV in FIG. 3;

FIG. 5 is a cross-sectional view taken along line V-V in FIG. 3;

FIG. 6 is a cross-sectional view taken along line VI-VI in FIG. 5;

FIG. 7 is a cross-sectional view taken along line VII-VII in FIG. 5; and

FIG. 8 is an exploded perspective view of the camera module.

### DESCRIPTION OF THE EMBODIMENTS

An embodiment of a camera module will hereinafter be described with reference to the drawings.

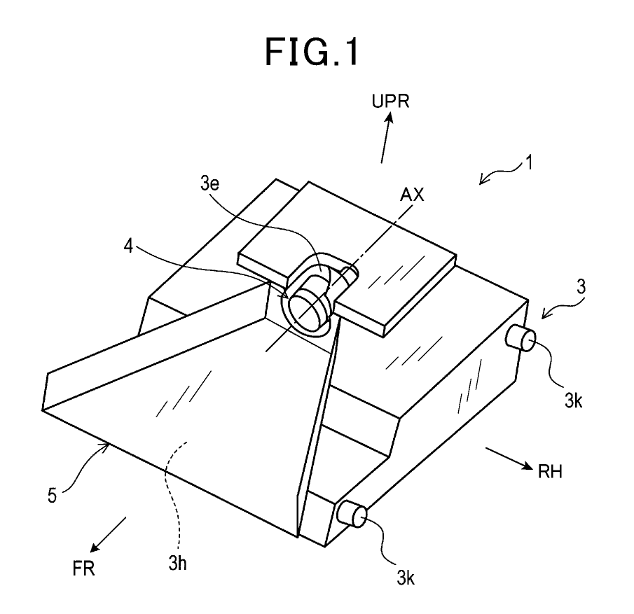

According to the present embodiment, as shown in FIG. 1, a camera module 4 is presumed to be applied to a camera apparatus 1 that is mounted to a vehicle (not shown). First, an overview of the camera apparatus 1 will be described.

The camera apparatus 1 is an on-board camera that is attached, from within a vehicle cabin of the vehicle, to a bracket (not shown) that is fixed to a windshield (not shown) of the vehicle. Hereafter, frontward, rearward, leftward, rightward, upward, and downward directions of each component of the camera apparatus 1 are defined as the frontward, rearward, leftward, rightward, upward, and downward directions of the component in a state in which the camera apparatus 1 is attached to the windshield. That is, based on this definition, the frontward direction of a component coincides with the direction ahead of the vehicle. In addition, FR, UPR, and RH directions in the drawings respectively indicate the frontward direction, the upward direction, and the rightward direction.

The camera apparatus 1 is configured such that the camera module 4 and a hood 5 are fixed to a camera case 3. The camera case 3 is a box-shaped component composed of metal or resin. The camera case 3 is shaped such that the thickness decreases towards the front side. Two latching portions 3k each are provided the outer side surfaces on the left and right sides of the camera case 3. The four latching portions 3k latch to hook portions of the bracket, thereby fixing the camera case 3 to the windshield.

The camera module 4 includes a lens 41, described hereafter. The camera module 4 is fixed within the camera case 3 such that a direction of an optical axis AX of the lens 41 coincides with the frontward-rearward direction of the camera case 3. An exposure hole 3e is formed in the camera case 3, from the front surface to the top surface. The lens 41 of the camera module 4 is exposed from the exposure hole 3e.

The hood 5 is fitted into a recess 3h in the camera case 3. The recess 3h is formed in front of and below the exposure hole 3e. The hood 5 covers the lens exposed from the exposure hole 3e, from below. As a result of the hood 5 being arranged in this manner, light entering from below the lens 41 is blocked, thereby making it possible to suppress a situation in which scenery outside of the range of the angle of view of the camera module 4 is reflected in the lens 41.

### 1. Configuration

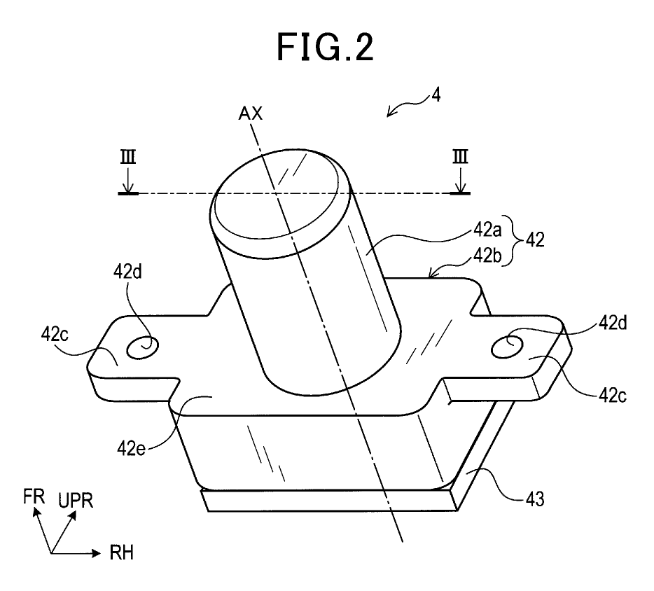

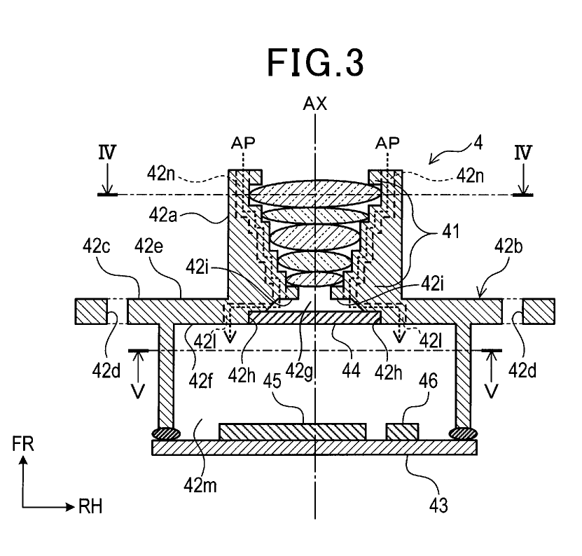

Next, a detailed configuration of the camera module 4 will be described. As shown in FIG. 2 and FIG. 3, the camera module 4 is a single-lens camera module that includes an optical unit 42 and a camera substrate 43.

The optical unit 42 includes a lens barrel portion 42a and a base portion 42b. The lens barrel portion 42a and the base portion 42b are integrally molded with resin. Thermoplastic resin, such as polyphenylene sulfide (PPS) resin, is used as the resin. In cases in which the lens barrel portion 42a and the base portion 42b are separate components, the lens barrel portion 42a and the base portion 42b require assembly. However, when the two components are assembled, the components may rub against each other and produce foreign matter. In this regard, as a result of the lens barrel portion 42a and the base portion 42b being integrally molded with resin, production of foreign matter is suppressed.

The lens barrel portion 42a is tube-shaped and holds the lens 41 therein. The lens 41 is composed of a plurality of lenses of differing sizes. The lenses of the lens 41 are arrayed in a direction of the optical axis AX of the lens 41 such that the optical axis AX coincides with a center axis of the lens barrel portion 42a. The size of the lens 41 herein refers to a diameter of the lens 41.

According to the present embodiment, as shown in FIG. 3, the lenses of the lens 41 are arranged such that the size of the lens 41 becomes smaller towards the rear. The inner diameter of the lens barrel portion 42a also becomes smaller. As a result of the lens barrel portion 42a being shaped in this manner, a mold for forming the inner wall surface of the lens barrel portion 42a can be removed from the front of the lens barrel portion 42a. Therefore, the lens barrel portion 42a and the base portion 42b can be integrally molded with ease. An optical axis hereafter refers to the optical axis AX of the lenses 41.

The base portion 42b has a rectangular parallelepiped shape that extends in the direction perpendicular to the optical axis AX and is open at the rear. Specifically, the base portion 42b includes a plate-shaped reference surface 42e and four plate-shaped side surfaces. The reference surface 42e serves as a reference for positioning when the camera module 4 is fixed to the camera case 3. The four side surfaces are upper, lower, left, and right side surfaces that stand erect from the reference surface 42e. The lengths of the upper, lower, left, and right side surfaces in the frontward-rearward direction are all identical.

Furthermore, the base portion 42b includes an attaching portion 42c for fixing the camera module 4 to the camera case 3. The attaching portion 42c is a plate-shaped portion that extends in the left-hand direction and the right-hand direction from the reference plate 42e. The attaching portion 42c and the surface of the reference surface 42e on the frontward side are flush. Screw holes 42d are formed in the attaching portion 42c. The camera module 4 is fixed to the camera case 3 by the attaching portion 42c being fastened with screws to a left-side inner wall and a right-side inner wall of the camera case 3.

The reference surface 42e is provided with a through hole 42g that passes through the reference surface 42e in the center portion of the reference surface 42e. The through hole 42g is formed such that the diameter thereof is smaller than the outer diameter of the lens barrel portion 42a and larger than the inner diameter of the lens barrel portion 42a on the rear end side. The lens barrel portion 42a is disposed on the outer wall surface side of the reference surface 42e in a position continuous with the through hole 42g and blocking the through hole 42g. Therefore, the interior of the lens barrel portion 42a and the through hole are connected. The camera substrate 43, described hereafter, is assembled to an open end portion at the rear of the base portion 42b. A base inner space 42m that is surrounded by the base portion 42b and the camera substrate 43 is thereby formed.

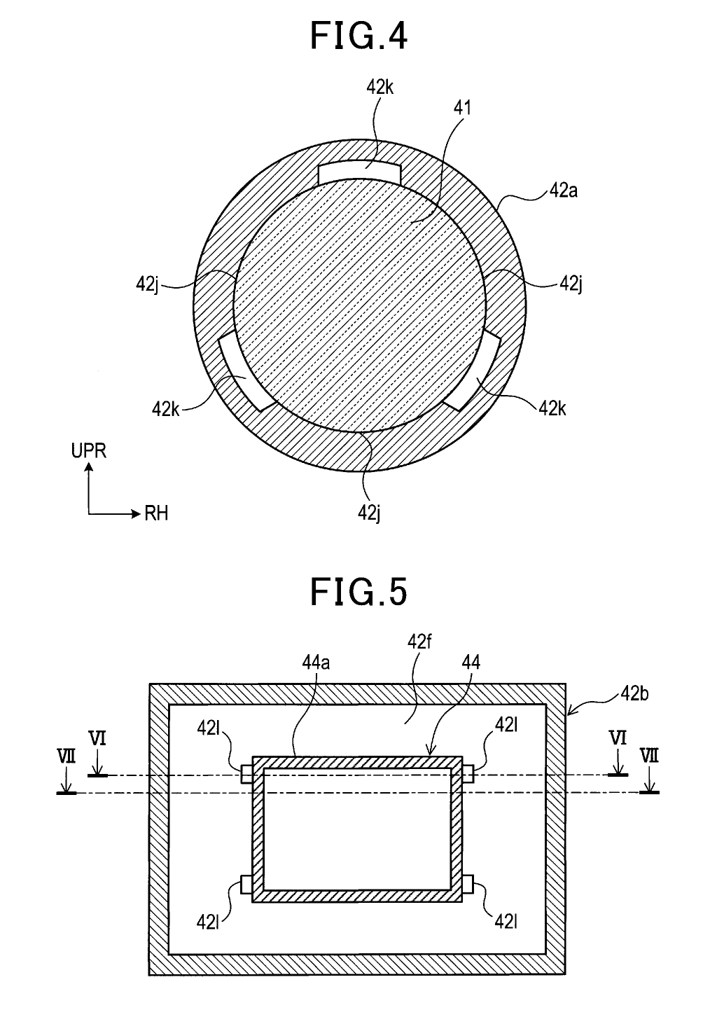

The tube-shaped wall of the lens barrel portion 42a is formed so as to partially surround the periphery of the lens 41. Specifically, as shown in FIG. 4, the lens barrel portion 42a includes surrounding portions 42j and gaps 42k. The surrounding portions 42j partially surround the periphery of the lens 41. The gaps 42k are disposed between the portions of the periphery of the lens 41 that are not surrounded by the surrounding portion 42j and the tube-shaped wall. On a cross-section perpendicular to the optical axis AX, the surrounding portion 42j is a section in which the tube-shaped wall is thick and in contact with the lens 41. The gap 42k is a gap between the inner wall surface in a section in which the tube-shaped wall is thin and the periphery of the lens 41. The gaps 42k formed in the periphery of the lens 41 are formed such that the lengths in a radial direction of the lens barrel portion 42a are approximately identical.

The gaps 42k formed in the periphery of the lens 41 are connected from the tip of the lens barrel portion 42a to the through hole 42g in the direction of the optical axis AX. Air holes 42n are thereby formed. The air hole 42n is a hole that communicates from the tip of the lens barrel portion 42a to the through hole 42g in the direction of the optical axis AX. The air holes 42n allow passage of air from the tip of the lens barrel portion 42a to the through hole 42g.

As described above, the sizes of the lenses of the lens 41 differ. Therefore, the distance from the optical axis AX to the gap 42k formed in the periphery of the lens 41 differs on the cross-section perpendicular to the optical axis AX. Consequently, the gap 42k formed in the periphery of a lens of the lens 41 is connected to the gaps 42k in the periphery of the lenses of the lens 41 that are adjacent to the lens in the direction of the optical axis AX. However, the positions of the gaps 42k in the radial direction of the lens barrel portion 42a are shifted. Therefore, the air hole 42n is shaped so as to bend a plurality of times on the cross-section parallel to the optical axis AX. That is, the air hole 42n has a labyrinth-like shape through which foreign matter that has flowed into the interior does not easily flow out.

As long as the gap 42k formed in the periphery of a lens of the lens 41 is connected to the gaps 42k formed in the periphery of the lenses adjacent in the direction of the optical axis AX, the positions of the gaps 42k in the circumferential direction of the lens barrel portion 42a may be shifted. When the positions of the gaps 42k in the circumferential direction are also shifted, the air hole 42n can be formed into a more complex shape and foreign matter can be kept within the air hole 42n. In addition, for example, the sizes of the lenses of the lens 41 may be equal, and the positions of the gaps 42k formed in the periphery of the lenses may be shifted in only the circumferential direction.

The periphery of each lens of the lens 41 is surrounded by the surrounding portions 42j and is positioned within the lens barrel 42a. After the lenses of the lens 41 are successively housed and positioned within the lens barrel portion 42a, the inner wall of the lens barrel portion 42a in the rear portion of the lens of the lens 41 closest to the base portion 42b side is heated. The shape of the inner wall is deformed and a fixing portion 42i is formed. The lens 41 is fixed to the interior of the tube-shaped wall by the fixing portion 42i that is integrally formed with the resin forming the tube-shaped wall of the lens barrel portion 42a. That is, after the lens 41 is housed in the lens barrel portion 42a, the inner wall of the lens barrel portion 42a on the base portion 42b side is thermally caulked. The lens 41 is thereby fixed within the lens barrel portion 42a.

An inner wall surface 42f of the reference surface 42e is provided with a fixing groove 42h for fixing an optical filter 44. The fixing groove 42h is formed so as to be coupled to the inner wall surface of the through hole 42g and to surround the through hole 42g. In cases in which the optical filter 44 is rectangular, the fixing groove 42h is formed such that the outline of the cross-section perpendicular to the optical axis AX is rectangular. The reference surface 42e corresponds to an opposing surface. The fixing groove 42h corresponds to a fixing region.

The optical filter 44 cuts off light of a predetermined wavelength. For example, the optical filter 44 is an infrared cut-off filter that cuts off infrared rays. The infrared cut-off filter is disposed between the lens 41 and the image sensor 45, described hereafter. Thus, when imaging is performed in an environment that has a large amount of infrared rays, such as outdoors, a situation in which the image becomes white as a result of saturation of electrical charge is suppressed.

An adhesive is applied to an overlap 44a of a predetermined width provided along the outer periphery of the optical filter 44. The optical filter 44 is thereby fixed to the fixing groove 42h in the reference surface 42e. At this time, the adhesive is applied to the fixing groove 42h of the reference surface 42e or the overlap 44a of the optical filter 44 so as to have thickness so as not to seal air channels (air grooves) 421. The adhesive is then sandwiched between the base portion 42b and the optical filter 44 and flattened. The position in which the adhesive is applied is, for example, the position of the fixing groove 42h or the overlap 44a corresponding to an area between adjacent air channels 421. In addition, the thickness of the adhesive is at least a thickness that prevents separation from a curing agent. For example, the thickness of the adhesive ranges from 0.01 mm to 1 mm.

The reference surface 42e is further provided with the air channels 421 that communicates between the base inner space 42m and the through hole 42g. As shown in FIG. 5, on the cross-section perpendicular to the optical axis AX, the air channel 421 extends further towards the side surface of the base portion 42b than the outer periphery of the optical filter 44 fixed to the fixing groove 42h. That is, the air channels 421 are not blocked by the optical filter 44.

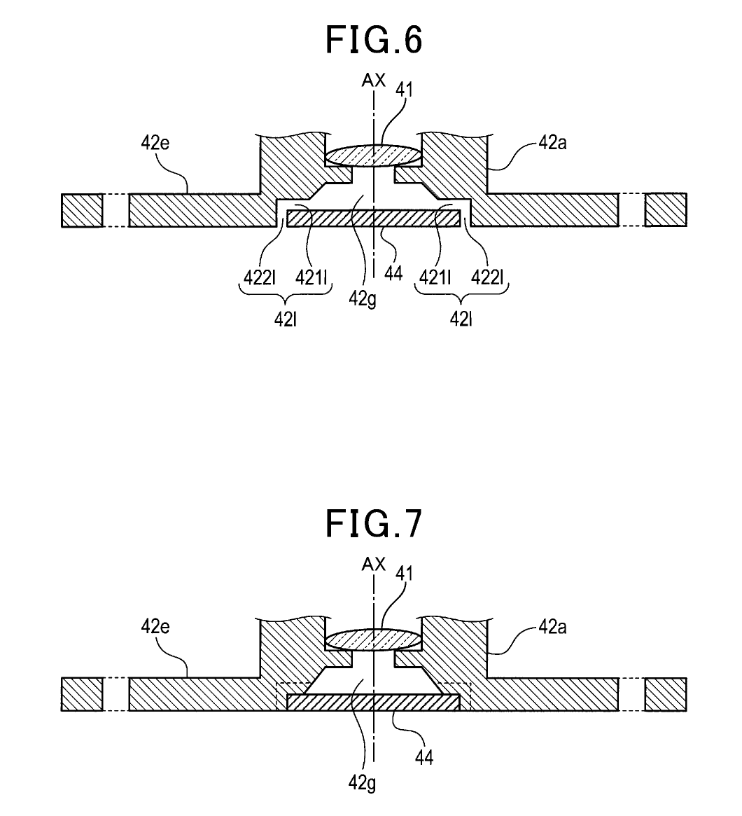

FIG. 6 is a cross-sectional view taken along a cross-section parallel to the optical axis AX in a section in which the air channels 421 are formed. FIG. 7 is a cross-sectional view taken along the cross-section parallel to the optical axis AX in a section in which the air channels 421 are not formed.

As shown in FIG. 6, the air channel 421 is formed along the optical filter 44, on the lens barrel portion 42a side and the reference surface 42e side of the optical filter 44. That is, the air channel 421 is formed on the outer side of the fixing groove 42h so as to be connected to the fixing groove 42h. Therefore, air flows from the through hole 42g to the base inner space 42m without being blocked by the optical filter 44. Meanwhile, as shown in FIG. 7, in the section in which the air channels 421 are not formed, the optical filter 44 is in contact with the reference surface 42e and air does not flow from the through hole 42g to the base inner space 42m.

In addition, as indicated by broken-line arrows in FIG. 3, air passages AP are formed by the air holes 42n formed in the lens barrel portion 42a, the through hole 42g, the air channels 421 formed in the reference surface 42e. Air flows through the air passage AP from the tip of the lens barrel portion 42a to the base inner space 42m. As a result, the base inner space 42m is not in a completely sealed state.

As shown in FIG. 6, the air channel 421 includes a first groove 4211 and a second groove 4221. The first groove 4211 extends beyond the fixing groove 42h from the inner wall surface of the through hole 42g, in the direction perpendicular to the optical axis AX. The second groove 4221 extends from the end portion of the first groove 4211 on the side opposite the through hole 42g towards the base inner space 42m in the direction of the optical axis AX. That is, the air channel 421 has a shape that bends on the cross-section parallel to the optical axis AX. Therefore, even when foreign matter flows from the through hole 42g into the air channel 421, the foreign matter tends to remain within the air channel 421 and does not easily flow out into the base inner space 42m. The labyrinth-structured air passage AP is formed from the tip of the lens barrel portion 42a to the base inner space 42m, by the air hole 42m and the air channel 421 being combined.

The shape of the lens barrel portion 42a is symmetrical with respect to the optical axis AX of the lens 41. The shape of the base portion 42b is symmetrical with respect to the optical axis AX of the lens 41. Here, when the lens barrel portion 42a and the base portion 42b are integrally molded with resin, a problem occurs in that it is difficult to obtain accuracy of the components. According to the present embodiment, as a result of the shapes of the lens barrel portion 42a and the base portion 42b being simple, decrease in accuracy of the components accompanying integral molding with resin can be suppressed.

The camera substrate 43 is a plate-shaped component on which the image sensor 45 and a connector 46 are mounted. According to the present embodiment, the connector 46 is mounted on the same side of the plate-shaped component as the image sensor 45. However, the connector 46 may be mounted on the opposite side of the plate-shaped component. The camera substrate 43 is assembled in the open end portion at the rear of the base portion 42b such that the surface on which the image sensor 45 is mounted faces the front. That is, the camera substrate 43 is assembled in the rear end portion of the base portion 42b such that the image sensor 45 opposes the optical filter 44 disposed on the inner wall surface of the reference surface 42e.

In a state in which the camera substrate 43 and the base portion 42b are assembled together, the camera substrate 43 and the base portion 42b are shaped such that relative positions thereof can be adjusted, rather than to fit closely together and mutually restrict movement. As described hereafter, the camera substrate 43 and the base portion 42b are fixed using an adhesive in a state in which the relative positions thereof are adjusted.

The image sensor 45 is a semiconductor image sensor element such as a charge-coupled device (CCD) image sensor or a complementary metal-oxide semiconductor (CMOS) image sensor. The image sensor 45 has a rectangular plate shape. The surface of the image sensor 45 is configured by a light receiving surface that forms a single plane. The image sensor 45 picks up a subject image formed on the light receiving surface by the lens 41 and outputs an image signal. At this time, when the light receiving surface of the image sensor 45 tilts with respect to the optical axis AX of the lens 41, partial blur or the like occurs and the quality of the image deteriorates. Therefore, the optical unit 42 and the camera substrate 43 are required to be positioned such that the light receiving surface of the image sensor 45 is accurately perpendicular to the optical axis AX of the lens 41. Adjustment of the relative positions of the optical unit 42 and the camera substrate 43 will be described hereafter.

In addition, in the camera case 3, a signal processing substrate and connection wiring are arranged below the camera module 4. The signal processing substrate is a plate-shaped component that processes the image signals acquired by the camera module 4. The signal processing substrate is provided with a connector. The connector of the signal processing substrate and the connector 46 of the camera substrate 43 are electrically connected by the connection wiring. Here, a component that captures the subject image and generates the image signal is the camera module 4.

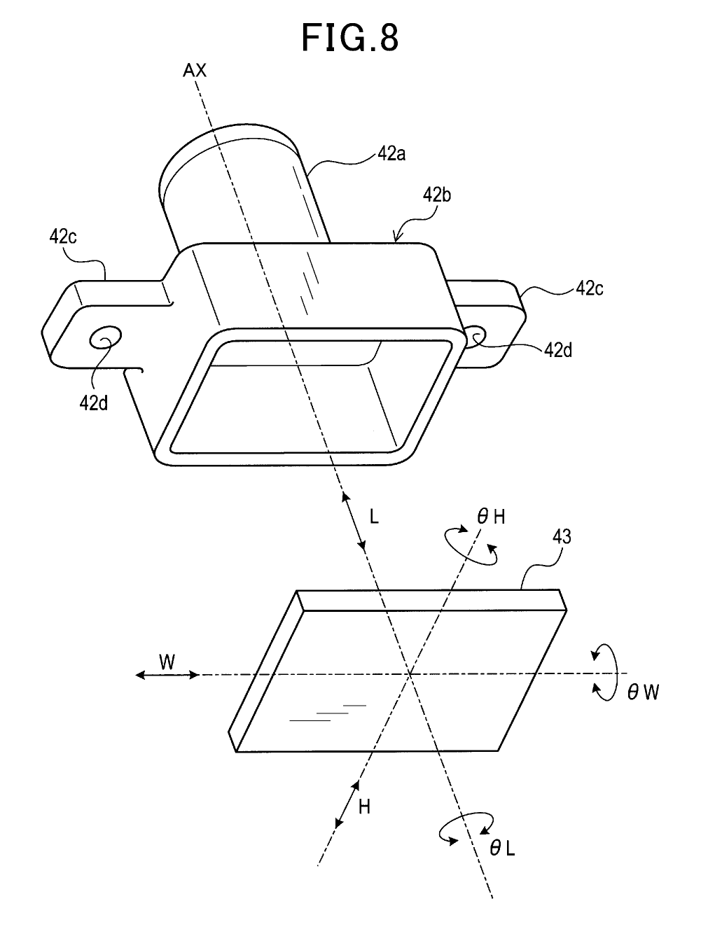

Next, adjustment of the relative positions of the optical unit 42 and the camera substrate 43, and fixing of the optical unit 42 and the camera substrate 43 will be described with reference to FIG. 8.

As described above, the relative positions of the optical unit 43 and the camera substrate 43 can be adjusted in a state in which the optical unit 42 and the camera substrate 43 are assembled together. Taking advantage of this degree of freedom, the relative position of the camera substrate 43 relative to the optical unit 42 is adjusted by six-axis adjustment. That is, the camera substrate 43 is fixed in a position relative to the optical unit 42 in which the optical axis AX of the lens 41 passes through the center of the light receiving surface of the image sensor 45 and is perpendicular to the light receiving surface of the image sensor 45. Six-axis adjustment herein refers to adjustment in translational directions on the x axis, y axis, and z axis, and a rotational direction around each axis. According to the present embodiment, the relative positions of the optical unit 42 and the camera substrate 43 are adjusted by adjusting the shape of the adhesive, such as the thickness or spread of the adhesive, being adjusted.

### 2. Effects

According to the first embodiment described in detail above, the following effects are achieved.

(1) The air channel 421 has a bent shape on the cross-section parallel to the optical axis AX. Therefore, even when foreign matter flows into the air channel 421 from the through hole 21g, the foreign matter tends to remain in the air channel 421 and does not easily flow out into the base inner space 42m in which the image sensor 45 is present. Consequently, foreign matter can be suppressed from adhering to the image sensor 45, even in a structure in which the base inner space 42m is not completely sealed.

(2) The first groove 4211 of the air channel 421 extends beyond the fixing groove 42h in the direction perpendicular to the optical axis AX. Therefore, the base inner space 42m is not completely sealed by the optical filter 44. Air can enter and exit between the base inner space 42m and the outside, through the through hole 42g and the air channels 421.

The positions of the gaps 42k formed in the periphery of the lenses of differing sizes of the lens 41 are shifted in the radial direction of the lens barrel portion 42a. Therefore, the air hole 42n formed by the gaps 42k connected in the direction of the optical axis AX has a labyrinth structure. As a result, even when foreign matter flows into the air hole 42n, the foreign matter tends to remain in the air hole 42n. Consequently, foreign matter can be suppressed from adhering to the image sensor 45.

(4) The lens 41 is fixed to the tube-shaped inner wall of the lens barrel portion 42a by thermal caulking. Therefore, compared to cases involving fastening with screws, foreign matter can be suppressed from being produced. Consequently, foreign matter can be suppressed from adhering to the image sensor 45.

(5) The lens barrel portion 42a and the base portion 42b are molded as an integrated component. Therefore, compared to cases in which the lens barrel portion 42a and the base portion 42b are molded as separate components, production of foreign matter can be suppressed. Consequently, foreign matter can be suppressed from adhering to the image sensor 45.

(6) The adhesive that fixes the optical filter 44 is applied between the base portion 42b and the optical filter 44 so as to have thickness, so as not to seal the air channels 421. As a result, separation from a curing agent can be suppressed without the air channels 421 being blocked by the adhesive. The optical filter 44 can be reliably fixed to the fixing groove 42h.

### Other Embodiments

The embodiment is described above. However, the present disclosure is not limited to the above-described embodiment. Various modifications are possible.

(1) According to the above-described embodiment, the lens barrel portion 42a and the base portion 42b are an integrated component. However, the lens barrel portion 42a and the base portion 42b may be separate components. As a result of the lens barrel portion 42a and the base portion 42b being formed into separate components, foreign matter tends to be more easily produced compared to when the lens barrel portion 42a and the base portion 42b are an integrated component. However, foreign matter can be suppressed from adhering to the image sensor 45 by the shapes of the air holes 42n and the air channels 421.

(2) According to the above-described embodiment, the lens 41 is fixed to the lens barrel portion 42a by thermal caulking. However, the present disclosure is not limited thereto. For example, the lens 41 may be fixed to the tube-shaped wall of the lens barrel portion 42a with screws. As a result of the lens 41 being fixed with screws, foreign matter tends to be more easily produced compared to when the lens 41 is fixed by thermal caulking. However, foreign matter can be suppressed from adhering to the image sensor 45 by the shapes of the air holes 42n and the air channels 421.

(3) According to the above-described embodiment, the air hole 42n has a labyrinth structure. However, the present disclosure is not limited thereto. For example, the air hole 42n may have a shape that is straight in the direction of the optical axis AX. Even when the air hole 42n is shaped in this manner, foreign matter that flows out from the air hole 42n tends to remain within the air channel 421. Consequently, foreign matter can be suppressed from adhering to the image sensor 45.

(4) According to the above-described embodiment, the fixing region for fixing the optical filter 44 to the base portion 42b is the fixing groove 42h. However, the present disclosure is not limited thereto. For example, the fixing region may be a protrusion-like latching portion formed on the inner wall surface 42f of the reference surface 42e. The optical filter 44 may be attached to the latching portion. In this case, the air channels 421 may be formed further towards the front than the latching portion.

(5) The camera module 4 may be applied to an apparatus other than the on-board camera apparatus 1. For example, the camera module 4 may be applied to a built-in camera of a mobile terminal, a personal computer, or the like.

(6) A plurality of functions provided by a single constituent element according to the above-described embodiment may be actualized by a plurality of constituent elements. Alternatively, a single function provided by a single constituent element may be actualized by a plurality of constituent elements. In addition, a plurality of functions provided by a plurality of constituent elements may be actualized by a single constituent element. Alternatively, a single function provided by a plurality of constituent elements may be actualized by a single constituent element. Furthermore, a part of a configuration according to the above-described embodiments may be omitted. In addition, at least a part of a configuration according to an above-described embodiment may be added to or replace a configuration according to another above-described embodiment. All aspects included in the technical concept identified solely by the expressions recited in the claims are embodiments of the present disclosure.

What is claimed is:

1. A camera module comprising:
a camera substrate that includes an image sensor;
a base portion that is a case fixed to the camera substrate so as to surround the image sensor and includes a through hole passing through an opposing surface that opposes the camera substrate;
a tube-shaped lens barrel portion that holds a lens therein and is disposed so as to communicate with the through hole on an outer wall surface side of the opposing surface; and
an optical filter that is fixed to a fixing region formed on an inner wall surface of the opposing surface,
the lens barrel portion including an air hole that communicates from a tip of the lens barrel portion to the through hole, through a tube-shaped wall of the lens barrel portion in a direction of an optical axis of the lens,
the opposing surface including an air channel that communicates between and the through hole and a base inner space, the base inner space being a space surrounded by the base portion and the camera substrate,
the air channel having a bent shape on a cross-section parallel to the optical axis.

2. The camera module according to claim 1, wherein:
the air channel includes:
a first groove that extends beyond the fixing region from an inner wall surface of the through hole in a direction perpendicular to the optical axis; and
a second groove that extends from an end portion of the first groove on a side opposite the through hole towards the base inner space in the direction of the optical axis.

3. The camera module according to claim 2, wherein:
the lens is a plurality of lenses of differing sizes that are arrayed in the direction of the optical axis;
the lens barrel portion includes a surrounding portion that partially surrounds the periphery of each lens and a gap between the tube-shaped wall and a portion of the periphery of each lens that is not surrounded by the surrounding portion;
the air hole is formed by the gaps connected in the direction of the optical axis.

4. The camera module according to claim 3, wherein:
the lens barrel portion is molded with resin; and
the lens is fixed within the tube-shaped wall by a fixing portion that is integrally formed with the resin forming the tube-shaped wall.

5. The camera module according to claim 4, wherein:
the lens barrel portion and the base portion are integrally molded with resin.

6. The camera module according to claim 5, wherein:
the optical filter is fixed to the fixing region with an adhesive; and
the adhesive is arranged between the base portion and the optical filter at a thickness of 0.01 mm to 1 mm, so as not to block the air channel.

7. The camera module according to claim 1, wherein:
the lens is a plurality of lenses of differing sizes that are arrayed in the direction of the optical axis;
the lens barrel portion includes a surrounding portion that partially surrounds the periphery of each lens and a gap between the tube-shaped wall and a portion of the periphery of each lens that is not surrounded by the surrounding portion;
the air hole is formed by the gaps connected in the direction of the optical axis.

8. The camera module according to claim 1, wherein:
the lens barrel portion is molded with resin; and
the lens is fixed within the tube-shaped wall by a fixing portion that is integrally formed with the resin forming the tube-shaped wall.

9. The camera module according to claim 1, wherein:
the lens barrel portion and the base portion are integrally molded with resin.

10. The camera module according to claim 1, wherein:
the optical filter is fixed to the fixing region with an adhesive; and
the adhesive is arranged between the base portion and the optical filter at a thickness of 0.01 mm to 1 mm, so as not to block the air channel.

11. An apparatus comprising:
a camera module; and
a case to which the camera module is mounted,
the camera module comprising:
a camera substrate that includes an image sensor;
a base portion that is a case fixed to the camera substrate so as to surround the image sensor and includes a through hole passing through an opposing surface that opposes the camera substrate;
a tube-shaped lens barrel portion that holds a lens therein and is disposed so as to communicate with the through hole on an outer wall surface side of the opposing surface; and
an optical filter that is fixed to a fixing region formed on an inner wall surface of the opposing surface,
the lens barrel portion including an air hole that communicates from a tip of the lens barrel portion to the through hole, through a tube-shaped wall of the lens barrel portion in a direction of an optical axis of the lens,
the opposing surface including an air channel that communicates between and the through hole and a base inner space, the base inner space being a space surrounded by the base portion and the camera substrate,
the air channel having a bent shape on a cross-section parallel to the optical axis.
